(19) United States
(12) Patent Application Publication
(10) Pub. No.: US 2024/0331515 A1
(43) Pub. Date: Oct. 3, 2024

(54) AUTOMATED ANIMAL DETECTION AND RESPONSE

(71) Applicant: Tyco Fire & Security GmbH, Neuhausen am Rheinfall (CH)

(72) Inventors: Jason M. OUELLETTE, Leominster, MA (US); Glenn Kilburn Holton, Braintree, MA (US); Sanela Suljic, Nashua, NH (US); Saravanabavanandam Sadaksharam, Coimbatore (IN)

(21) Appl. No.: 18/616,781

(22) Filed: Mar. 26, 2024

Related U.S. Application Data
(60) Provisional application No. 63/492,426, filed on Mar. 27, 2023.

(51) Int. Cl. G08B 13/18; G08B 7/06

(52) U.S. Cl. CPC G08B 13/18; G08B 7/06

(57) ABSTRACT

Example implementations include a method, apparatus and computer-readable medium for automated animal detection, comprising receiving one or more data sets from one or more sensors associated with a security system. The implementations further include generating an animal detection score for a detected animal based at least in part on the one or more data sets from the one or more sensors. Additionally, the implementations further include causing autonomous execution of one or more intrusion response actions based on the animal detection score satisfying a threshold detection score.

### CROSS REFERENCE TO RELATED APPLICATION(S)

This application claims priority to U.S. Provisional Application Ser. No. 63/492,426, entitled “AUTOMATED ANIMAL DETECTION AND RESPONSE” and filed on Mar. 27, 2023, which is expressly incorporated by reference herein in the entirety.

### FIELD

The present disclosure generally relates to security systems. More particularly, the present disclosure relates to implementing systems and methods for automated animal detection and response.

### BACKGROUND

Security systems are configured to allow security personnel of a building to manage security, surveillance, access, emergency alerts, and other similar activities associated with the building. Generally, these security systems are configured to receive data from a sensor, such as an image sensor, a motion sensor, and/or the like, and identify and/or detect illegal or unauthorized activities in the building or within a perimeter of an area around the building based on the data received from the sensor. For example, these security systems can be configured to determine whether there are any attempts of unauthorized access to restricted areas of a building, breach of any perimeters or barriers of a building, and/or the like, based on the data received from a sensor.

However, these security systems may inaccurately identify and/or detect some activities as illegal or unauthorized activities and consequently generate false alarms or alerts. For example, a security system that receives data from an image sensor or a camera may falsely identify changes in certain light patterns or shadows from inanimate objects as a person or animal and generate a false alarm and/or alert. Such false alarms and/or alerts can cause the security personnel to not trust the security systems, thus, reducing the integrity of these systems. Furthermore, such false alarms and/or alerts can result in manual intervention and assessment by the security personnel, which can further delay or prevent any timely responses to the situation before any damage occurs.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

An example aspect includes a method for automated animal detection, comprising receiving one or more data sets from one or more sensors associated with a security system. The method further includes generating an animal detection score for a detected animal based at least in part on the one or more data sets from the one or more sensors. Additionally, the method further includes causing autonomous execution of one or more intrusion response actions based on the animal detection score satisfying a threshold detection score.

Another example aspect includes an apparatus for automated animal detection, comprising one or more memories storing instructions, and one or more processors coupled with the one or more memories. The one or more processors, individually or in combination, are configured to execute the instructions to receive one or more data sets from one or more sensors associated with a security system. The one or more processors, individually or in combination, are further configured to execute the instructions to generate an animal detection score for a detected animal based at least in part on the one or more data sets from the one or more sensors. Additionally, the one or more processors, individually or in combination, are further configured to execute the instructions to cause autonomous execution of one or more intrusion response actions based on the animal detection score satisfying a threshold detection score.

Another example aspect includes an apparatus for automated animal detection, comprising means for receiving one or more data sets from one or more sensors associated with a security system. The apparatus further includes means for generating an animal detection score for a detected animal based at least in part on the one or more data sets from the one or more sensors. Additionally, the apparatus further includes means for causing autonomous execution of one or more intrusion response actions based on the animal detection score satisfying a threshold detection score.

Another example aspect includes one or more computer-readable media having instructions stored thereon for automated animal detection, wherein the instructions are executable by one or more processors, individually or in combination, to receive one or more data sets from one or more sensors associated with a security system. The instructions are further executable by the one or more processors, individually or in combination, to generate an animal detection score for a detected animal based at least in part on the one or more data sets from the one or more sensors. Additionally, the instructions are further executable by the one or more processors, individually or in combination, to cause autonomous execution of one or more intrusion response actions based on the animal detection score satisfying a threshold detection score.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, wherein dashed lines may indicate optional elements, and in which:

FIG. 1 is a diagram including an example of a computing device that detects animal and/or human presence in an area associated with a building with improved accuracy, in accordance with various aspects of the present disclosure;

FIG. 2 is a block diagram of an example of a computing device having components configured to perform a method for automated animal detection, in accordance with various aspects of the present disclosure;

FIG. 3 is a flowchart of an example of a method for automated animal detection, in accordance with various aspects of the present disclosure;

FIG. 4 is a flowchart of additional optional aspects of the method of FIG. 3 for generating an animal detection score, in accordance with various aspects of the present disclosure;

FIG. 5 is a flowchart of additional optional aspects of the method of FIG. 3 for detecting a second animal, in accordance with various aspects of the present disclosure; and

FIG. 6 is a flowchart of additional optional aspects of the method of FIG. 3 for using received configuration information for detecting an animal, in accordance with various aspects of the present disclosure.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspects may be practiced without these specific details.

Aspects described herein relate to a security system that can be configured to autonomously detect presence of one or more types of animals within an area associated with a building. The security system may be associated with the building and/or may be communicatively coupled with or integrated with a building management system. The security system may be communicatively coupled with multiple sensors. Examples of the sensors may include, but are not limited to, thermal sensors, motion sensors, image sensors, cameras, and the like. The multiple sensors may be positioned in different parts of the area associated with the building, and the security system may be configured to receive data from the multiple sensors and/or obtain data outputted from the multiple sensors.

Based on the received and/or obtained data from the multiple sensors, the security system may be configured to detect presence of a live animal within the area associated with the building and generate a corresponding animal detection score. However, rather than relying upon a single source of data (e.g., data from one sensor) to generate the animal detection score, the security system may be configured to use data from different sensors to generate the animal detection score. The animal detection score may indicate a confidence level associated with the detection of the animal.

Additionally, the security system may be configured to autonomously execute one or more response actions (e.g., autonomously activate one or more response events) based on the animal detection score satisfying a threshold score and/or a threshold confidence level.

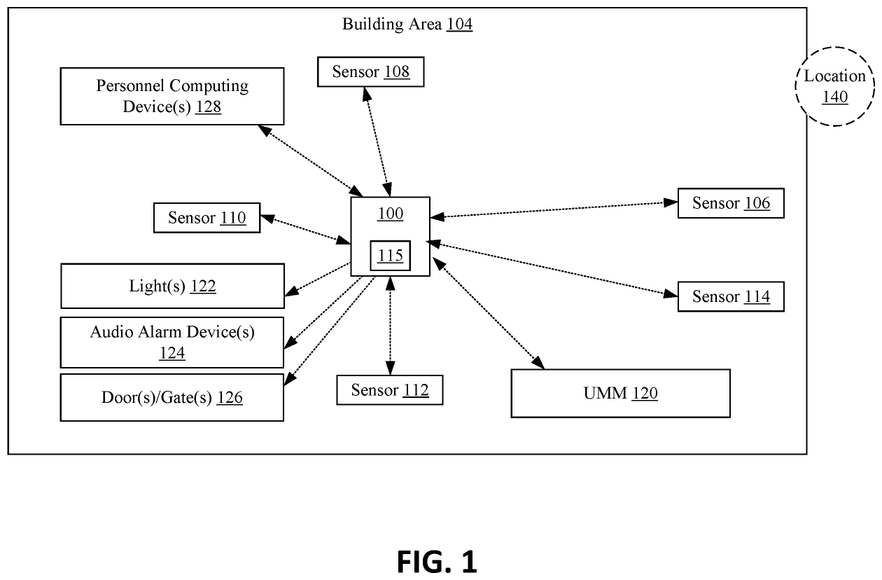

The security system may also be configured to receive various configurations related to animal detection, responses, and/or sensors. For example, the security system may be configured to receive configurations indicating one or more threshold detection scores. Similarly, the configurations may indicate one or more sensors to be used for and/or removed from the determination of the detection score, and the configurations may indicate one or more attributes associated with the one or more sensors and their corresponding values. By configuring the security system to receive different configurations, the security system can be dynamically adapted to different user requirements (e.g., requirements of security personnel), and/or different types of buildings, environments, or locations (e.g., office buildings, houses, urban environments, country-side environments, parks, and the like). Additional details related to the security system, its configurations, and the generation of the animal detection score are described below with respect to FIGS. 1-6.

Referring to FIG. 1, an example computing device 100 provides and/or hosts a security system 115. The security system 115 may be configured to monitor for various types of activities or issues within a building area 104. The building area 104 may be an area associated with a building and/or a structure (e.g., an office building, a house, a park, and the like). The building area 104 may include an interior of a building and/or a structure, and/or an exterior of a building and/or a structure, such as a defined perimeter and the like of the building and/or the structure. In some implementations, the defined perimeter of the building may be an area covering a threshold amount of area surrounding the building and/or the structure. In some implementations, the size of the perimeter of the building, and thus, the building area 104, may be provided as a user input and/or indicated in a configuration file received by the security system 115. The various types of activities or issues may include, but are not limited to, presence of animals (e.g., live animals), animal intrusions, and the like.

The security system 115 may be communicatively coupled with multiple sensors, such as sensors 106, 108, 110, 112, 114. Examples of sensors 106, 108, 110, 112, 114 may include, but are not limited to, thermal sensors and non-thermal sensors, such as image sensors, cameras, smoke sensors, air quality sensors, light sensors, audio sensors, microphones, audible sensors, heating, ventilation and air conditioning (HVAC) operational sensors, or substantially any sensor that can monitor a condition within the building area 104 for detecting the various types of activities or issues (e.g., presence of animals, animal intrusions, and the like). In some implementations, the security system 115 may be communicatively coupled with sensors 106, 108, 110, 112, 114 via a wired connection and/or a wireless connection. The security system 115 may be configured to receive and/or obtain data from the sensors 106, 108, 110, 112, 114. The security system 115 may receive and/or obtain the data from the sensors 106, 108, 110, 112, 114 in real-time or near real-time.

The security system 115 may detect presence of one or more animals within the building area 104 based on the data from the sensors 106, 108, 110, 112, 114. In some implementations, the security system 115 may be configured to receive a configuration indicating a set of animals or animal types of interest (referred to herein as animals of interest), and the one or more detected animals are animals or animal types indicated in the set. In some implementations, the security system 115 may be configured with a default or a predetermined set of animals of interest. In some implementations, the security system 115 may be configured to monitor for and detect animals indicated in the set of animals of interest.

The security system 115 may be configured to receive configurations of one or more attributes of animals and their corresponding values, and the attributes and their corresponding values may be associated with one or more sensors 106, 108, 110, 112, 114. In some implementations, the security system 115 may receive the attributes and their corresponding values from a user (e.g., security personnel) via a user interface (e.g., a graphical user interface (GUI)) associated with the security system 115. Examples of attributes may include, but are not limited to, a shape of an animal, a color of an animal, and/or other features of an animal, and examples of corresponding values of the attributes may include, but are not limited to, various shapes of the animal, various colors (e.g., red, blue, green (RGB) color values) of the animal, and the like. In some implementations, different attributes may be associated with different sensors 106, 108, 110, 112, 114. For example, the attribute indicating a color of an animal may be associated with an image sensor or a camera, but may not be associated with a thermal sensor.

The security system 115 may be configured with and/or may utilize various artificial intelligence (AI) models (e.g., machine learning models, and the like) that are trained to classify animals into different categories or types of animals based on data from sensors such as sensors 106, 108, 110, 112, 114. For example, but not limited hereto, one or more of the AI models may be trained to classify bears in thermal image data. Similarly, one or more of the AI models may be trained to classify colors of bears in data from image sensors or cameras.

The security system 115 may be configured to provide the data from the sensors 106, 108, 110, 112, 114, as an input to the trained AI models, to determine and/or detect presence of a live animal or an animal of interest within the building area 104. The security system 115 may generate an animal detection score for the animal detected in the data from the sensors 106, 108, 110, 112, 114. The animal detection score may indicate a confidence level associated with the detection of the animal in the data from the sensors 106, 108, 110, 112, 114.

In some implementations, to generate the animal detection score, the security system 115 may generate an initial detection score based on detection of an animal and/or an attribute of an animal in the data from one of the sensors 106, 108, 110, 112, 114. The security system 115 may then modify the initial detection score based on whether the animal and/or the attribute of the animal is detected in data from other sensors 106, 108, 110, 112, 114. For example, if sensor 106 is a thermal sensor, the security system 115 may initially detect a bear in the thermal image data from sensor 106, and may generate an initial detection score. The security system 115 may then determine whether the bear is also detected in data from other sensors, such as image data from an image sensor or camera (e.g., sensor 108). If the security system 115 determines that the bear is also detected in the image data, then the security system may increase the initial detection score, and if the security system 115 determines that the bear is not detected in the image data, then the security system may decrease the initial detection score. Similarly, the security system 115 may determine whether the bear is detected in data from the remaining sensors, and modify (e.g., increase or decrease) the initial detection score accordingly. The generated animal detection score is based on a final modified initial detection score. For example, the final modified initial detection score may be the animal detection score. Thus, by determining whether an animal is detected across multiple data sources, the likelihood of a false detection is significantly reduced, if not eliminated, while the accuracy and the integrity of the security system 115 is increased.

In some implementations, each of the attributes associated with the sensors 106, 108, 110, 112, 114 may be associated with different scores, and the security system 115 may generate the initial detection score based on whether a corresponding value of an attribute associated with a sensor is detected in the data from that sensor.

In some implementations, the security system 115 may generate the initial detection score based on a confidence level indicated by an output of a trained AI model. For example, if an output of an AI model trained to classify an animal in thermal image data indicates a 98 percent probability of a presence of a bear, then the security system 115 may generate a higher initial score than if the output indicated a 95 percent probability of a presence of a bear. In some implementations, the amount by which the initial detection score is modified by the security system 115 may be based on the confidence levels of outputs of trained AI models utilized to detect the animal and/or the attribute of the animal in the data from the remaining sensors 106, 108, 110, 112, 114. In some implementations, the security system 115 may increase or decrease the initial detection score by a user-defined or a predetermined amount.

The security system 115 may determine whether the animal detection score satisfies a threshold detection score, and the security system 115 may cause execution and/or activation of one or more intrusion response actions and/or events based on the animal detection score satisfying s the threshold detection score. In some implementations, the threshold detection scores may be user-defined or predetermined. In some implementations, different threshold detection scores may be defined or predetermined for different environments. By defining different threshold scores or being configured with different predetermined threshold scores for different environments, the security system 115 may be dynamically adjusted to the different environments without compromising the accuracy and integrity of the security system 115. For example, if the building and/or the structure is located in a state park, then a higher threshold detection score may be defined than a threshold detection score defined for an urban environment because it may be more likely for more animals to be near the building area 104 without posing a threat to human life (e.g., animals passing by the building area 104) when the building and/or the structure is in a state park than if the building and/or the structure is in an urban environment. Thus, having a higher threshold detection score for a state park environment can further reduce false detection of animals being within the building area 104, and prevent execution and/or activation of one or more intrusion response actions for such false positive detections.

Examples of intrusion response actions and/or events may include, but are not limited to, launching of one or more unmanned mobile machines (UMMs) 120 (e.g., drones, and the like) associated with the security system 115 and/or the building, powering on one or more lights 122 associated with the security system 115 and/or the building, flashing or turning on a set of the lights 122 in a sequence, powering on one or more audio alarm devices 124 (e.g., sounder alarm devices, and other noise making alarm devices, speakers, and the like), locking one or more access doors or access gates 126 associated with the security system 115 and/or the building, transmitting alerts to one or more computing devices 128 of personnel associated with the security system 115 and/or the building, and the like.

The security system 115 may be communicatively coupled (e.g., via wired and/or wireless connections) with the one or more UMMs 120, the one or more lights 122, the one or more audio alarm devices 124, the one or more access doors or access gates 126, the one or more computing devices 128 of the personnel, etc. The security system 115 may be configured to generate and/or or transmit a command (e.g., an alert, an instruction message, a signal, and the like) configured to cause and/or initiate the powering on, flashing, and/or turning on the one or more lights 122, powering on the one or more audio alarm devices 124, launching of the one or more UMMs 120, transmission of the alerts to the one or more computing devices 128 of personnel associated with the security system 115, and the like. The security system 115 may be configured to generate and/or transmit a command configured to cause, initiate, and/or actuate locking of the one or more access doors and/or access gates 126.

In some implementations, the security system 115 may be configured with and/or may receive geographical and/or location data of the building area 104, and may be configured with locations (e.g., via a map and/or a mapping of locations) of the UMMs, the audio alarm devices 124, lights 122, access doors/access gates 126, computing devices 128 of the personnel, and/or other devices associated with response actions/events within the building area 104. Based on the configured locations of the audio alarm devices 124, lights 122, access doors/access gates 126, and the like, the security system 115 may be configured to determine and/or identify one or more of the UMMs 120, audio alarm devices 124, lights 122, access doors/access gates 126, and the like, that are closest to or within a threshold distance of the location (e.g., location relative to the building area 104) of the detected animal, such as location 140, and cause the execution and/or activation of one or more intrusion response actions and/or events using the one or more of the identified UMMs 120, audio alarm devices 124, lights 122, access doors/access gates 126, and the like, that are closest to or within threshold distance of the location of the detected animal, such as location 140.

For example, if the animal detection score satisfies the threshold detection score, then the security system 115 may identify one or more audio alarm devices 124, lights 122, and the like, that are within threshold distance of the location 140, and power on the identified one or more audio alarm devices 124, the lights 122, and the like. Similarly, the security system 115 may identify one or more UMMs 120 (e.g., drones) within a threshold distance of the location 140, and may cause the identified one or more UMMs 120 to travel to the location 140 by providing them the location 140. The security system 115 may be configured to indicate the location 140 in alerts and/or alarms transmitted to the one or more computing devices 128 of personnel associated with the security system 115 and/or the building.

In some implementations, the security system 115 may be configured with profiles of one or more domesticated animals (e.g., pets) or children of interest, and/or may be configured to receive data related to the profiles of the one or more domesticated animals or children of interest. In some implementations, the security system 115 may detect presence of a domesticated animal (e.g., pets) or a child within the building area 104 based on data from sensors 106, 108, 110, 112, 114, and/or other building management systems (e.g., check-in systems, and the like) with which the security system 115 may be communicatively coupled, and the data related to the profiles of the one or more domesticated animals or children of interest. For example, the security system 115 may compare the detected domesticated animal or the child with one or more profiles of the one or more domesticated animals or children of interest.

In response to detecting the presence of the animal and/or determining that the animal detection score satisfies a threshold detection score, the security system 115 may determine whether the domesticated animal or the child is present within the building or outside of the building. If the security system determines that the domesticated animal is within the building, then the security system 115 may autonomously lock access doors/access gates 126 associated with the domesticated animal. For example, if the domesticated animal is a dog, then the security system 115 may autonomously lock pet doors to prevent the dog from going outside. If the security system 115 determines that the domesticated animal is outside of the building, then the security system 115 may indicate a location of the domesticated animal and/or a presence of the domesticated animal in one or more of the transmitted alerts to the security personnel computing devices 128.

In some implementations, the security system 115 may be configured with various levels of detection threshold scores, and the different levels of animal detection threshold scores may be associated with different levels of alerts and/or alarms. In response to the animal detection score satisfying a certain threshold detection score or a level of threshold detection score, the security system 115 may be configured to transmit a level of an alert and/or alarm associated with the threshold detection score or the level of threshold detection score.

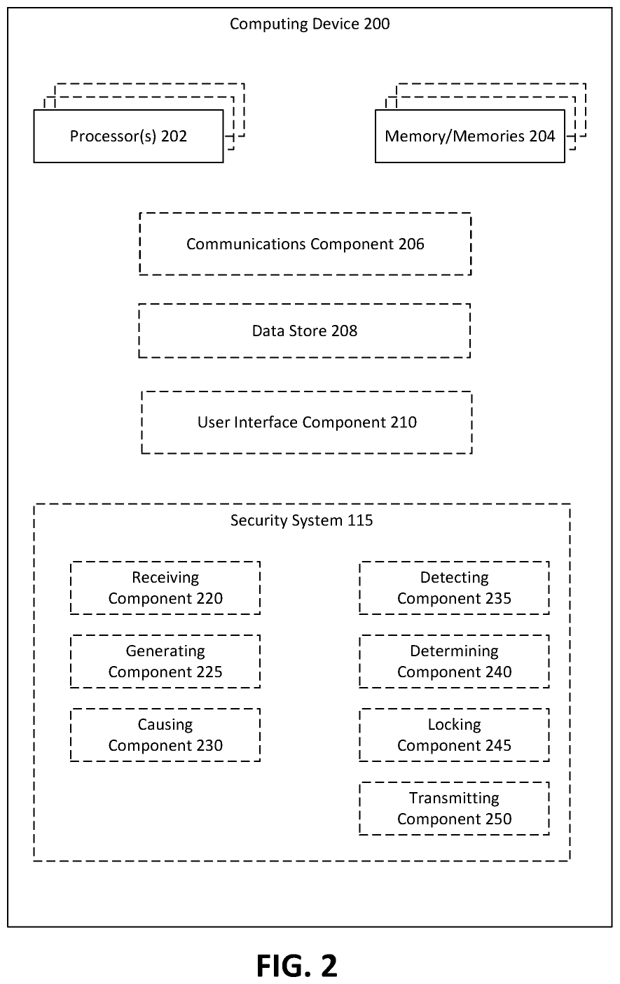

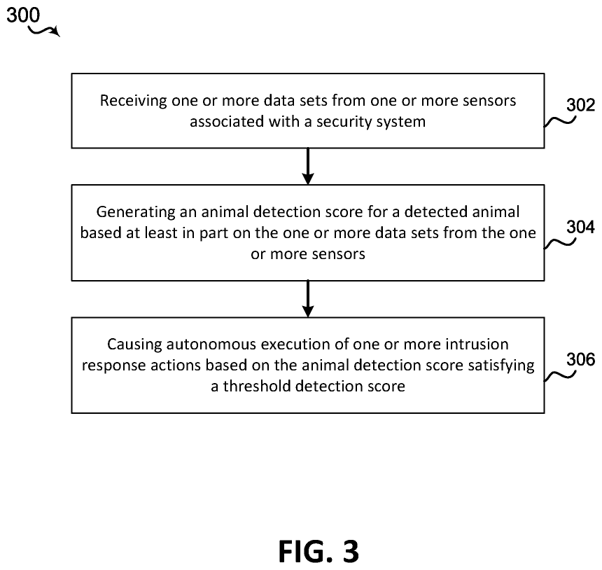

Referring to FIG. 2, a computing device 200 may implement all or a portion of the functionality described with reference to FIG. 1 above or with reference to FIGS. 3-6 below. For example, the computing device 200 may be or may include or may implement at least a portion of the computing device 100, the security system 115, the sensors 106, 108, 110, 112, 114, the UMMs 120, the lights 122, the audio alarm devices 124, the doors/gates 126, the personnel computing devices 128, or any other component described herein with reference to FIG. 1 above or with reference to FIGS. 3-6 below. The computing device 200 includes one or more processors 202 which, individually or in combination, may be configured to execute or implement software, hardware, and/or firmware modules that perform some or all of the functionality described herein with reference to FIG. 1 above or with reference to FIGS. 3-6 below. For example, the one or more processors 202, individually or in combination, may be configured to execute or implement software, hardware, and/or firmware modules that perform some or all of the functionality described herein with reference to the computing device 100, the security system 115, the sensors 106, 108, 110, 112, 114, the UMMs 120, the lights 122, the audio alarm devices 124, the doors/gates 126, the computing devices 128, or any other component described herein with reference to FIG. 1 above or with reference to FIGS. 3-6 below.

As used herein, a processor, at least one processor, and/or one or more processors, individually or in combination, configured to perform or operable for performing a plurality of actions is meant to include at least two different processors able to perform different, overlapping or non-overlapping subsets of the plurality actions, or a single processor able to perform all of the plurality of actions. In one non-limiting example of multiple processors being able to perform different ones of the plurality of actions in combination, a description of a processor, at least one processor, and/or one or more processors configured or operable to perform actions X, Y, and Z may include at least a first processor configured or operable to perform a first subset of X, Y, and Z (e.g., to perform X) and at least a second processor configured or operable to perform a second subset of X, Y, and Z (e.g., to perform Y and Z). Alternatively, a first processor, a second processor, and a third processor may be respectively configured or operable to perform a respective one of actions X, Y, and Z. It should be understood that any combination of one or more processors each may be configured or operable to perform any one or any combination of a plurality of actions.

The one or more processors 202 may include a micro-controller, an application-specific integrated circuit (ASIC), or a field-programmable gate array (FPGA), and/or may include a single or multiple set of processors or multi-core processors. Moreover, the one or more processors 202 may be implemented as an integrated processing system and/or a distributed processing system. The computing device 200 may further include one or more memories 204, such as for storing local versions of applications being executed by the one or more processors 202, related instructions, parameters, etc.

As used herein, a memory, at least one memory, and/or one or more memories, individually or in combination, configured to store or having stored thereon instructions executable by one or more processors for performing a plurality of actions is meant to include at least two different memories able to store different, overlapping or non-overlapping subsets of the instructions for performing different, overlapping or non-overlapping subsets of the plurality actions, or a single memory able to store the instructions for performing all of the plurality of actions. In one non-limiting example of one or more memories, individually or in combination, being able to store different subsets of the instructions for performing different ones of the plurality of actions, a description of a memory, at least one memory, and/or one or more memories configured or operable to store or having stored thereon instructions for performing actions X, Y, and Z may include at least a first memory configured or operable to store or having stored thereon a first subset of instructions for performing a first subset of X, Y, and Z (e.g., instructions to perform X) and at least a second memory configured or operable to store or having stored thereon a second subset of instructions for performing a second subset of X, Y, and Z (e.g., instructions to perform Y and Z). Alternatively, a first memory, and second memory, and a third memory may be respectively configured to store or have stored thereon a respective one of a first subset of instructions for performing X, a second subset of instruction for performing Y, and a third subset of instructions for performing Z. It should be understood that any combination of one or more memories each may be configured or operable to store or have stored thereon any one or any combination of instructions executable by one or more processors to perform any one or any combination of a plurality of actions. Moreover, one or more processors may each be coupled to at least one of the one or more memories and configured or operable to execute the instructions to perform the plurality of actions. For instance, in the above non-limiting example of the different subset of instructions for performing actions X, Y, and Z, a first processor may be coupled to a first memory storing instructions for performing action X, and at least a second processor may be coupled to at least a second memory storing instructions for performing actions Y and Z, and the first processor and the second processor may, In combination, execute the respective subset of instructions to accomplish performing actions X, Y, and Z. Alternatively, three processors may access one of three different memories each storing one of instructions for performing X, Y, or Z, and the three processor may in combination execute the respective subset of instruction to accomplish performing actions X, Y, and Z. Alternatively, a single processor may execute the instructions stored on a single memory, or distributed across multiple memories, to accomplish performing actions X, Y, and Z.

The one or more memories 204 may include a type of memory usable by a computer, such as random access memory (RAM), read only memory (ROM), tapes, magnetic discs, optical discs, volatile memory, non-volatile memory, and any combination thereof. Additionally, the one or more processors 202 and the one or more memories 204 may include and execute an operating system executing on the one or more processors 202, one or more applications, display drivers, etc., and/or other components of the computing device 200.

Further, the computing device 200 may include a communications component 206 that provides for establishing and maintaining communications with one or more other devices, parties, entities, etc. utilizing hardware, software, and services. The communications component 206 may carry communications between components on the computing device 200, as well as between the computing device 200 and external devices, such as devices located across a communications network and/or devices serially or locally connected to the computing device 200. In an aspect, for example, the communications component 206 may include one or more buses, and may further include a transceiver. For example, the communications component 206 may include transmit chain components and receive chain components associated with a wireless or wired transmitter and receiver, respectively, operable for interfacing with external devices.

Additionally, the computing device 200 may include a data store 208, which can be any suitable combination of hardware and/or software, that provides for storage (e.g., mass storage) of information, databases, and programs. For example, the data store 208 may be or may include a data repository for applications and/or related parameters not currently being executed by the one or more processors 202. In addition, the data store 208 may be a data repository for an operating system, application, display driver, etc., executing on the one or more processors 202, and/or one or more other components of the computing device 200.

The computing device 200 may also include a user interface component 210 operable to receive inputs from a user of the computing device 200 and further operable to generate outputs for presentation to the user (e.g., via a display interface to a display device). The user interface component 210 may include one or more input devices, including but not limited to a keyboard, a number pad, a mouse, a touch-sensitive display, a navigation key, a function key, a microphone, a voice recognition component, or any other mechanism capable of receiving an input from a user, or any combination thereof. Further, the user interface component 210 may include one or more output devices, including but not limited to a display interface, a speaker, a haptic feedback mechanism, a printer, any other mechanism capable of presenting an output to a user, or any combination thereof.

In some aspects, the security system 115 may include a receiving component 220, a generating component 225, a causing component 230, a detecting component 235, a determining component 240, a locking component 245, and/or a transmitting component 250, as described below.

Referring to FIGS. 2-6s, in operation, computing device 200 may perform a method 300 for automated animal detection, by such as via execution of one or more components of the security system 115 by one or more processors 202, individually or in combination, and/or one or more memories 204, individually or in combination.

At block 302, the method 300 includes receiving one or more data sets from one or more sensors associated with a security system. For example, in an aspect, computing device 200, one or more processors 202, individually or in combination, one or more memories 204, individually or in combination, security system 115, and/or receiving component 220 may be configured to or may comprise means for receiving one or more data sets from one or more sensors associated with a security system.

For example, the receiving at block 302 may include the computing device 100 receiving the one or more data sets via a wired connection and/or a wireless connection (e.g., via a wireless signal received the computing device 100) from one or more of the sensors 106, 108, 110, 112, 114 associated with the building area 104.

Further, for example, the receiving at block 302 may be performed to autonomously detect an animal within an area associated with a building (e.g., building area 104).

At block 304, the method 300 includes generating an animal detection score for a detected animal based at least in part on the one or more data sets from the one or more sensors. For example, in an aspect, computing device 200, one or more processors 202, individually or in combination, one or more memories 204, individually or in combination, security system 115, and/or generating component 225 may be configured to or may comprise means for generating an animal detection score for a detected animal based at least in part on the one or more data sets from the one or more sensors.

For example, the generating at block 304 may include the computing device 100 providing data of one or more data sets as an input to one or more models trained to detect animals and/or to one or more algorithms configured to detect animals, and generating an animal detection score based on detection of an animal in multiple data sets of the one or more data sets.

Further, for example, the generating at block 304 may be performed to use more than one sensor or sensor type to detect presence of an animal more accurately and to reduce false positive detections, and further to improve integrity of a security system (e.g., security system 115).

At block 306, the method 300 includes causing autonomous execution of one or more intrusion response actions based on the animal detection score satisfying a threshold detection score. For example, in an aspect, computing device 200, one or more processors 202, individually or in combination, one or more memories 204, individually or in combination, security system 115, and/or causing component 230 may be configured to or may comprise means for causing autonomous execution of one or more intrusion response actions based on the animal detection score satisfying a threshold detection score.

For example, the causing at block 306 may include the computing device 100 generating and/or transmitting a command to UMMs 120, lights 122, audio alarm devices 124, doors/gates 126, personnel computing devices 128, etc., to cause and/or initiate the one or more intrusion response actions and/or events, for example, as described above with respect to FIG. 1.

Further, for example, the causing at block 306 may be performed to reduce or eliminate user or human intervention in initiating a response to an intrusion, and/or to improve latency in responding to intrusions.

In an alternative or additional aspect, the animal detection score indicates a confidence level associated with a detection of the detected animal.

In an alternative or additional aspect, at least a first sensor of the one or more sensors is a thermal sensor and at least a second sensor of the one or more sensors is a non-thermal sensor.

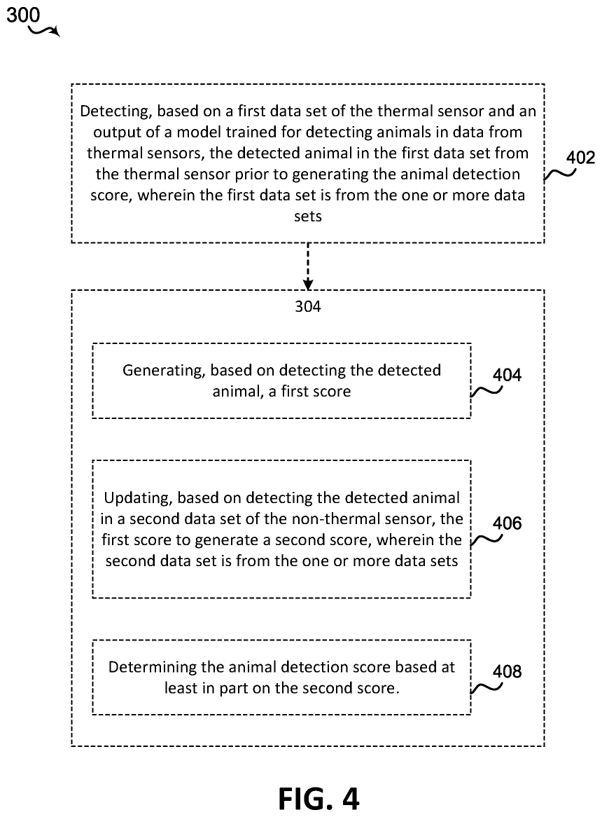

Referring to FIG. 4, in an alternative or additional aspect wherein at least a first sensor of the one or more sensors is a thermal sensor and at least a second sensor of the one or more sensors is a non-thermal sensor, at optional block 402, the method 300 may further include detecting, based on a first data set of the thermal sensor and an output of a model trained for detecting animals in data from thermal sensors, the detected animal in the first data set from the thermal sensor prior to generating the animal detection score, wherein the first data set is from the one or more data sets. For example, in an aspect, computing device 200, one or more processors 202, individually or in combination, one or more memories 204, individually or in combination, security system 115, and/or detecting component 235 may be configured to or may comprise means for detecting, based on a first data set of the thermal sensor and an output of a model trained for detecting animals in data from thermal sensors, the detected animal in the first data set from the thermal sensor prior to generating the animal detection score, wherein the first data set is from the one or more data sets.

For example, the detecting at optional block 402 may include the computing device 100 providing as an input, thermal image data from a thermal sensor (e.g., a sensor from sensors 106, 108, 110, 112, 114), to an AI model (e.g., a machine learning model) trained to detect animals in thermal image data, prior to generating the animal detection score at block 304.

Further, for example, the detecting at optional block 402 may be performed to detect live presence of an animal within an area associated with a building (e.g., building area 104).

In this optional aspect, at optional block 404, the generating at optional block 304 of the animal detection score may further include generating, based on detecting the detected animal, a first score.

For example, the generating at optional block 404 may be performed based on a defined or predetermined initial score for detection of an animal, or a confidence level indicated by an output of a model (e.g., AI trained models).

In this optional aspect, at optional block 406, the generating at optional block 304 of the animal detection score may further include updating, based on detecting the detected animal in a second data set of the non-thermal sensor, the first score to generate a second score, wherein the second data set is from the one or more data sets.

For example, the updating at optional block 406 may be performed by increasing the first score when the animal is detected in data sets from one or more non-thermal sensors, as described above, or decreasing the first score when the animal is not detected in the data sets from the non-thermal sensors.

In this optional aspect, at optional block 408, the generating at optional block 304 of the animal detection score may further include determining the animal detection score based at least in part on the second score.

For example, the determining at optional block 408 may include setting the animal detection score as the second score such that the animal detection score is based on data from more than one source (e.g., data from more than one sensor of the sensors 106, 108, 110, 112, 114).

In an alternative or additional aspect, the second data set of the non-thermal sensor is generated within a threshold period of time as the first data set from the thermal sensor.

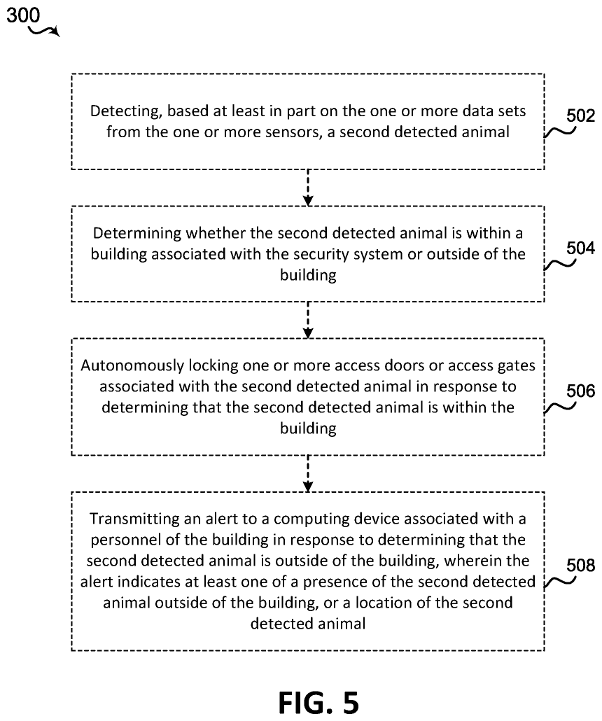

Referring to FIG. 5, in an alternative or additional aspect, at optional block 502, the method 300 may further include detecting, based at least in part on the one or more data sets from the one or more sensors, a second detected animal. For example, in an aspect, computing device 200, one or more processors 202, individually or in combination, one or more memories 204, individually or in combination, security system 115, and/or detecting component 235 may be configured to or may comprise means for detecting, based at least in part on the one or more data sets from the one or more sensors, a second detected animal.

For example, the detecting at optional block 502 may include the computing device 100 detecting a second animal (e.g., a domesticated animal, such as a pet) within an area associated with the building (e.g., building area 104).

Further, for example, the detecting at optional block 502 may be performed to prevent pets from engaging with any intruding animals that may pose a threat of injury to the pets.

In this optional aspect, at optional block 504, the method 300 may further include determining whether the second detected animal is within a building associated with the security system or outside of the building. For example, in an aspect, computing device 200, one or more processors 202, individually or in combination, one or more memories 204, individually or in combination, security system 115, and/or determining component 240 may be configured to or may comprise means for determining whether the second detected animal is within a building associated with the security system or outside of the building.

For example, the determining at optional block 504 may include the computing device 100 identifying a location of the detected second animal based on data from sensors (e.g., sensors 106, 108, 110, 112, 114) and corresponding locations of the sensors.

In this optional aspect, at block optional 506, the method 300 may further include autonomously locking one or more access doors or access gates associated with the second detected animal in response to determining that the second detected animal is within the building. For example, in an aspect, computing device 200, one or more processors 202, individually or in combination, one or more memories 204, individually or in combination, security system 115, and/or locking component 245 may be configured to or may comprise means for autonomously locking one or more access doors or access gates associated with the second detected animal in response to determining that the second detected animal is within the building.

For example, the locking at optional block 506 may include the computing device 100 generating and/or transmitting a command (e.g., an instruction, a message, and the like) configured to actuate and/or initiate locking of one or more access doors (e.g., pet doors) and/or access gates (doors/gates 126) of the building, where the access doors/gates 126 are configured for the second animal (e.g., the domesticated animal) to use.

Further, for example, the locking at optional block 506 may be performed to prevent the detected second animal to engage with the intruding animal and to reduce the likelihood of injury for the second animal.

In this optional aspect, at optional block 508, the method 300 may further include transmitting an alert to a computing device associated with a personnel of the building in response to determining that the second detected animal is outside of the building, wherein the alert indicates at least one of a presence of the second detected animal outside of the building, or a location of the second detected animal. For example, in an aspect, computing device 200, one or more processors 202, individually or in combination, one or more memories 204, individually or in combination, security system 115, and/or transmitting component 250 may be configured to or may comprise means for transmitting an alert to a computing device associated with a personnel of the building in response to determining that the second detected animal is outside of the building, wherein the alert indicates at least one of a presence of the second detected animal outside of the building, or a location of the second detected animal.

For example, the transmitting at optional block 508 may include the computing device 100 transmitting the alert to one or more personnel computing devices 128 via a wired connection and/or a wireless connection (e.g., via a wireless signal from the computing device 100).

Further, for example, the transmitting at optional block 508 may be performed to rapidly alert security personnel that the second animal may be at a high risk of injury and/or to improve response time in reducing the risk of injury to the second animal.

In an alternative or additional aspect, each sensor of the one or more sensors is associated with a set of user-configured attributes, and a corresponding data set of each sensor associated with the one or more data sets includes one or more values for the set of user-configured attributes.

In an alternative or additional aspect, the one or more intrusion response actions include at least one of launching of one or more drones (e.g., UMMs 120) associated with the security system, powering on one or more lights 122 associated with the security system, powering on one or more noise makers (e.g., audio alarm devices 124) associated with the security system, powering on one or more sounders (e.g., audio alarm devices 124) associated with the security system, locking one or more access doors or access gates (e.g., doors/gates 126) associated with the security system, or transmitting alerts to one or more computing devices 128 of personnel associated with the security system.

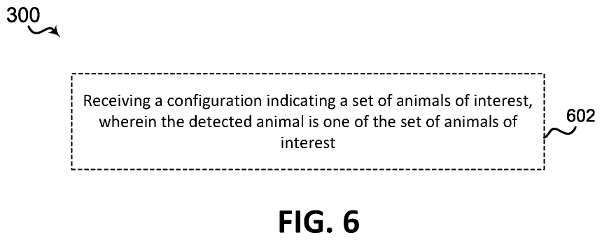

Referring to FIG. 6, in an alternative or additional aspect, at optional block 602, the method 300 may further include receiving a configuration indicating a set of animals of interest, wherein the detected animal is one of the set of animals of interest. For example, in an aspect, computing device 200, one or more processors 202, individually or in combination, one or more memories 204, individually or in combination, security system 115, and/or receiving component 220 may be configured to or may comprise means for receiving a configuration indicating a set of animals of interest, wherein the detected animal is one of the set of animals of interest.

For example, the receiving at optional block 602 may include the computing device 100 receiving a configuration indicating a set of animals of interest (e.g., wild animals such as bears, raccoons, deer, geese, domesticated animals such as dogs and cats, etc.) via a wired connection and/or a wireless connection (e.g., via a wireless signal received by the computing device 100).

Further, for example, the receiving at optional block 602 may be performed to dynamically adjust the types or categories of animals that the security system (e.g., security system 115) may detect and/or to allow the security system to be adjusted to different environments where the types or categories of animals that are likely to intrude may be different.

The following examples are illustrative only and may be combined with aspects of other embodiments or teachings described herein, without limitation.

1. A method for automated animal detection, comprising:
receiving one or more data sets from one or more sensors associated with a security system;
generating an animal detection score for a detected animal based at least in part on the one or more data sets from the one or more sensors; and
causing autonomous execution of one or more intrusion response actions based on the animal detection score satisfying a threshold detection score.

2. The method of clause 1, wherein the animal detection score indicates a confidence level associated with a detection of the detected animal.

3. The method of any one of the preceding clauses, wherein at least a first sensor of the one or more sensors is a thermal sensor and at least a second sensor of the one or more sensors is a non-thermal sensor.

4. The method of any one of the preceding clauses, further comprising:
detecting, based on a first data set of the thermal sensor and an output of a model trained for detecting animals in data from thermal sensors, the detected animal in the first data set from the thermal sensor prior to generating the animal detection score, wherein the first data set is from the one or more data sets.

5. The method of any one of the preceding clauses, wherein generating the animal detection score further comprises:
generating, based on detecting the detected animal, a first score;
updating, based on detecting the detected animal in a second data set of the non-thermal sensor, the first score to generate a second score, wherein the second data set is from the one or more data sets; and
determining the animal detection score based at least in part on the second score.

6. The method of any one of the preceding clauses, wherein the second data set of the non-thermal sensor is generated within a threshold period of time as the first data set from the thermal sensor.

7. The method of any one of the preceding clauses, further comprising:
detecting, based at least in part on the one or more data sets from the one or more sensors, a second detected animal;
determining whether the second detected animal is within a building associated with the security system or outside of the building; and
autonomously locking one or more access doors or access gates associated with the second detected animal in response to determining that the second detected animal is within the building.

8. The method of any one of the preceding clauses, further comprising:
transmitting an alert to a computing device associated with a personnel of the building in response to determining that the second detected animal is outside of the building, wherein the alert indicates at least one of a presence of the second detected animal outside of the building, or a location of the second detected animal.

9. The method of any one of the preceding clauses, wherein each sensor of the one or more sensors is associated with a set of user-configured attributes, and wherein a corresponding data set of each sensor associated with the one or more data sets includes one or more values for the set of user-configured attributes.

10. The method of any one of the preceding clauses, wherein the one or more intrusion response actions include at least one of launching of one or more drones associated with the security system, powering on one or more lights associated with the security system, powering on one or more noise makers associated with the security system, powering on one or more sounders associated with the security system, locking one or more access doors or access gates associated with the security system, or transmitting alerts to one or more computing devices of personnel associated with the security system.

11. The method of any one of the preceding clauses, further comprising:
receiving a configuration indicating a set of animals of interest, wherein the detected animal is one of the set of animals of interest.

12. An apparatus for automated animal detection, comprising:
one or more memories storing instructions; and
one or more processors coupled with the one or more memories and, individually or in combination, configured to execute the instructions to:
receive one or more data sets from one or more sensors associated with a security system;
generate an animal detection score for a detected animal based at least in part on the one or more data sets from the one or more sensors; and
cause autonomous execution of one or more intrusion response actions based on the animal detection score satisfying a threshold detection score.

13. The apparatus of clause 12, wherein the animal detection score indicates a confidence level associated with a detection of the detected animal.

14. The apparatus of any one of clauses 12 or 13, wherein at least a first sensor of the one or more sensors is a thermal sensor and at least a second sensor of the one or more sensors is a non-thermal sensor.

15. The apparatus of any one of clauses 12 to 14, wherein the one or more processors, individually or in combination, are further configured to execute the instruction to:
detect, based on a first data set of the thermal sensor and an output of a model trained for detecting animals in data from thermal sensors, the detected animal in the first data set from the thermal sensor prior to generating the animal detection score, wherein the first data set is from the one or more data sets.

16. The apparatus of any one of clauses 12 to 15, wherein to generate the animal detection score, the one or more processors, individually or in combination, are further configured to execute the instruction to:
generate, based on detecting the detected animal, a first score;
update, based on detecting the detected animal in a second data set of the non-thermal sensor, the first score to generate a second score, wherein the second data set is from the one or more data sets; and
determine the animal detection score based at least in part on the second score.

17. The apparatus of any one of clauses 12 to 16, wherein the second data set of the non-thermal sensor is generated within a threshold period of time as the first data set from the thermal sensor.

18. The apparatus of any one of clauses 12 to 17, wherein the one or more processor, individually or in combination, are further configured to execute the instruction to:
detect, based at least in part on the one or more data sets from the one or more sensors, a second detected animal;
determine whether the second detected animal is within a building associated with the security system or outside of the building; and
autonomously lock one or more access doors or access gates associated with the second detected animal in response to determine that the second detected animal is within the building.

19. The apparatus of any one of clauses 12 to 18, wherein the one or more processors, individually or in combination, are further configured to execute the instructions to:
transmit an alert to a computing device associated with a personnel of the building in response to determining that the second detected animal is outside of the building, wherein the alert indicates at least one of a presence of the second detected animal outside of the building, or a location of the second detected animal.

20. The apparatus of any one of clauses 12 to 19, wherein each sensor of the one or more sensors is associated with a set of user-configured attributes, and wherein a corresponding data set of each sensor associated with the one or more data sets includes one or more values for the set of user-configured attributes.

21. The apparatus of any one of clauses 12 to 20, wherein the one or more intrusion response actions include at least one of launching of one or more drones associated with the security system, powering on one or more lights associated with the security system, powering on one or more noise makers associated with the security system, powering on one or more sounders associated with the security system, locking one or more access doors or access gates associated with the security system, or transmitting alerts to one or more computing devices of personnel associated with the security system.

22. The apparatus of any one of clauses 12 to 21, wherein the one or more processors, individually or in combination, are further configured to execute the instructions to:
receive a configuration indicating a set of animals of interest, wherein the detected animal is one of the set of animals of interest.

While the foregoing disclosure discusses illustrative aspects and/or embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

What is claimed is:

1. A method for automated animal detection, comprising:
receiving one or more data sets from one or more sensors associated with a security system;
generating an animal detection score for a detected animal based at least in part on the one or more data sets from the one or more sensors; and
causing autonomous execution of one or more intrusion response actions based on the animal detection score satisfying a threshold detection score.

2. The method of claim 1, wherein the animal detection score indicates a confidence level associated with a detection of the detected animal.

3. The method of claim 1, wherein at least a first sensor of the one or more sensors is a thermal sensor and at least a second sensor of the one or more sensors is a non-thermal sensor.

4. The method of claim 3, further comprising:
detecting, based on a first data set of the thermal sensor and an output of a model trained for detecting animals in data from thermal sensors, the detected animal in the first data set from the thermal sensor prior to generating the animal detection score, wherein the first data set is from the one or more data sets.

5. The method of claim 4, wherein generating the animal detection score further comprises:
generating, based on detecting the detected animal, a first score;
updating, based on detecting the detected animal in a second data set of the non-thermal sensor, the first score to generate a second score, wherein the second data set is from the one or more data sets; and
determining the animal detection score based at least in part on the second score.

6. The method of claim 5, wherein the second data set of the non-thermal sensor is generated within a threshold period of time as the first data set from the thermal sensor.

7. The method of claim 1, further comprising:
detecting, based at least in part on the one or more data sets from the one or more sensors, a second detected animal;
determining whether the second detected animal is within a building associated with the security system or outside of the building; and
autonomously locking one or more access doors or access gates associated with the second detected animal in response to determining that the second detected animal is within the building.

8. The method of claim 7, further comprising:
transmitting an alert to a computing device associated with a personnel of the building in response to determining that the second detected animal is outside of the building, wherein the alert indicates at least one of a presence of the second detected animal outside of the building, or a location of the second detected animal.

9. The method of claim 1, wherein each sensor of the one or more sensors is associated with a set of user-configured attributes, and wherein a corresponding data set of each sensor associated with the one or more data sets includes one or more values for the set of user-configured attributes.

10. The method of claim 1, wherein the one or more intrusion response actions include at least one of launching of one or more drones associated with the security system, powering on one or more lights associated with the security system, powering on one or more noise makers associated with the security system, powering on one or more sounders associated with the security system, locking one or more access doors or access gates associated with the security system, or transmitting alerts to one or more computing devices of personnel associated with the security system.

11. The method of claim 1, further comprising:
receiving a configuration indicating a set of animals of interest, wherein the detected animal is one of the set of animals of interest.

12. An apparatus for automated animal detection, comprising:
one or more memories storing instructions; and
one or more processors coupled with the one or more memories and, individually or in combination, configured to execute the instructions to:
receive one or more data sets from one or more sensors associated with a security system;
generate an animal detection score for a detected animal based at least in part on the one or more data sets from the one or more sensors; and
cause autonomous execution of one or more intrusion response actions based on the animal detection score satisfying a threshold detection score.

13. The apparatus of claim 12, wherein the animal detection score indicates a confidence level associated with a detection of the detected animal.

14. The apparatus of claim 12, wherein at least a first sensor of the one or more sensors is a thermal sensor and at least a second sensor of the one or more sensors is a non-thermal sensor.

15. The apparatus of claim 14, wherein the one or more processors, individually or in combination, are further configured to execute the instructions to:
detect, based on a first data set of the thermal sensor and an output of a model trained for detecting animals in data from thermal sensors, the detected animal in the first data set from the thermal sensor prior to generating the animal detection score, wherein the first data set is from the one or more data sets.

16. The apparatus of claim 15, wherein to generate the animal detection score, the one or more processors, individually or in combination, are further configured to execute the instructions to:
generate, based on detecting the detected animal, a first score;
update, based on detecting the detected animal in a second data set of the non-thermal sensor, the first score to generate a second score, wherein the second data set is from the one or more data sets; and
determine the animal detection score based at least in part on the second score.

17. The apparatus of claim 16, wherein the second data set of the non-thermal sensor is generated within a threshold period of time as the first data set from the thermal sensor.

18. The apparatus of claim 12, wherein the one or more processors, individually or in combination, are further configured to execute the instructions to:
detect, based at least in part on the one or more data sets from the one or more sensors, a second detected animal;
determine whether the second detected animal is within a building associated with the security system or outside of the building; and
autonomously lock one or more access doors or access gates associated with the second detected animal in response to determine that the second detected animal is within the building.

19. The apparatus of claim 18, wherein the one or more processors, individually or in combination, are further configured to execute the instructions to:
transmit an alert to a computing device associated with a personnel of the building in response to determining that the second detected animal is outside of the building, wherein the alert indicates at least one of a presence of the second detected animal outside of the building, or a location of the second detected animal.

20. The apparatus of claim 12, wherein each sensor of the one or more sensors is associated with a set of user-configured attributes, and wherein a corresponding data set of each sensor associated with the one or more data sets includes one or more values for the set of user-configured attributes.

21. The apparatus of claim 12, wherein the one or more intrusion response actions include at least one of launching of one or more drones associated with the security system, powering on one or more lights associated with the security system, powering on one or more noise makers associated with the security system, powering on one or more sounders associated with the security system, locking one or more access doors or access gates associated with the security system, or transmitting alerts to one or more computing devices of personnel associated with the security system.

22. The apparatus of claim 12, wherein the one or more processors, individually or in combination, are further configured to execute the instructions to:
receive a configuration indicating a set of animals of interest, wherein the detected animal is one of the set of animals of interest.
